(19) United States
(12) Patent Application Publication
(10) Pub. No.: US 2025/0056504 A1
(43) Pub. Date: Feb. 13, 2025

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Xiaohong ZHANG, Beijing (CN)

(73) Assignee: NEC CORPORATION, Tokyo (JP)

(21) Appl. No.: 18/723,087

(22) PCT Filed: Dec. 23, 2021
(86) PCT No.: PCT/CN2021/140938

§ 371 Date: Jun. 21, 2024

(51) Int. Cl. H04W 72/04

(52) U.S. Cl. CPC H04W 72/04

(57) ABSTRACT

Embodiments of the present disclosure relate to methods, devices and computer readable media for communication. A terminal device receives, from a network device, a first configuration for a set of UL resources, and determines a time window for the set of UL resources. The time window is associated with a DRX cycle. An UL resource within the time window in the set of UL resources is used for an UL transmission and an UL resource outside the time window in the set of UL resources is invalid for transmission. The uplink transmission comprises at least one of a scheduling request, a buffer status report, or a configured grant uplink transmission. In this way, an UL resource may be determined based on a time window associated with a DRX cycle, and a UL triggered DRX may be achieved. Thus, an alignment between DL and UL transmissions may be facilitated and power saving may be improved.

### TECHNICAL FIELD

Embodiments of the present disclosure generally relate to the field of telecommunication, and in particular, to methods, devices and computer storage media of communication for an alignment between downlink (DL) and uplink (UL) transmissions.

### BACKGROUND

Power saving is an important topic for services with periodic packets, especially for an extended reality (XR) service such as virtual reality (VR), augmented reality (AR), cloud gaming, etc. For DL transmissions, a discontinuous reception (DRX) operation is adopted for power saving. A terminal device is in an active time only during an on-duration of a DRX cycle. For UL transmissions, a scheduling request (SR) and a buffer status reporting (BSR) are key procedures to initiate UL transmissions. Comparing with a misalignment between the DL and UL transmissions, an alignment between the DL and UL transmissions would be more helpful in reducing awake time of a terminal device and accordingly reducing power consumption of the terminal device.

Typically, packets for services such as the XR service will arrive at radio access network (RAN) every 1/frames per second (FPS). The arriving tends to occur in a range of jitter due to various factors. An effect of jitter is identified as an important aspect for such services. However, the alignment between the DL and UL transmissions considering the effect of jitter is still incomplete and needs to be developed.

### SUMMARY

In general, embodiments of the present disclosure provide methods, devices and computer storage media of communication for an alignment between DL and UL transmissions.

In a first aspect, there is provided a method of communication. The method comprises: receiving, at a terminal device and from a network device, a first configuration for a set of uplink resources; and determining a time window for the set of uplink resources, the time window being associated with a DRX cycle, an uplink resource within the time window in the set of uplink resources being used for an uplink transmission and an uplink resource outside the time window in the set of uplink resources being invalid for transmission, wherein the uplink transmission comprises at least one of a SR, a BSR, or a configured grant UL transmission.

In a second aspect, there is provided a method of communication. The method comprises: transmitting, at a network device and to a terminal device, a first configuration for a set of uplink resources; and determining a time window for the set of uplink resources, the time window being associated with a DRX cycle, an uplink resource within the time window in the set of uplink resources being used for an uplink transmission and an uplink resource outside the time window in the set of uplink resources being invalid for transmission, wherein the uplink transmission comprises at least one of a SR, a BSR, or a configured grant UL transmission.

In a third aspect, there is provided a device of communication. The device comprises a processor configured to perform the method according to the first aspect of the present disclosure.

In a fourth aspect, there is provided a device of communication. The device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating an example operation in a DRX cycle;

FIG. 1C illustrates a schematic diagram illustrating an example operation of on-duration in a DRX cycle with WUS detection;

FIG. 2A illustrates a schematic diagram illustrating an example scenario of a misalignment between DL and UL transmissions;

FIG. 2B illustrates a schematic diagram illustrating an example scenario of an alignment between DL and UL transmissions;

FIG. 2C illustrates a schematic diagram illustrating an example configuration of UL resources considering an effect of jitter;

FIG. 3 illustrates a schematic diagram illustrating a process of communication according to embodiments of the present disclosure;

FIG. 4A illustrates a schematic diagram illustrating an example determination of a time window according to embodiments of the present disclosure;

FIG. 4B illustrates a schematic diagram illustrating another example determination of a time window according to embodiments of the present disclosure;

FIG. 5 illustrates a schematic diagram illustrating another process of communication according to embodiments of the present disclosure;

FIG. 6 illustrates a schematic diagram illustrating an example starting of an on-duration timer according to embodiments of the present disclosure;

FIG. 7 illustrates a schematic diagram illustrating still another process of communication according to embodiments of the present disclosure;

FIG. 8 illustrates a schematic diagram illustrating another example starting of an on-duration timer according to embodiments of the present disclosure;

FIG. 9 illustrates a schematic diagram illustrating yet another process of communication according to embodiments of the present disclosure;

FIG. 10 illustrates an example method of communication implemented at a terminal device in accordance with some embodiments of the present disclosure;

FIG. 11 illustrates an example method of communication implemented at a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “symbol” refers to an orthogonal frequency division multiplexing (OFDM) symbol or a discrete Fourier transform spread OFDM (DFT-s-OFDM) symbol. The term “slot” includes multiple consecutive symbols, e.g., 14 symbols, or 12 symbols. The term “mini-slot” includes one or more consecutive symbols, and has less symbol than a slot, e.g., 1, 2, 4, or 7 symbols. In the context of the present application, the term “DRX cycle” may refer to a long DRX cycle or a short DRX cycle or both.

As mentioned above, an effect of jitter is identified as an important aspect for services such as the XR service. Due to the effect of jitter and stringent packet delay budget (PDB) requirement in UL, dense uplink resources in time domain are beneficial to provide transmission occasions as early as possible after packets arrive. However, for the sake of power saving, sparse uplink resources and an alignment with a DL transmission are demanded to avoid frequent wake-up for an UL transmission such as SR or BSR. Obviously, the two requirements on the density of uplink resources are contradictory and should be resolved.

In view of this, embodiments of the present disclosure provide a solution for solving the above and other potential issues. In the solution, a time window is defined for an UL resource determination. A configured UL resource within the time window is used for an UL transmission and a configured UL resource outside the time window is invalid for transmission. In other words, dense UL resources are configured within the time window and no valid UL resource is configured outside the time window. The uplink transmission comprises at least one of a scheduling request, a buffer status report, or a configured grant uplink transmission. Further, the time window is associated with a DRX cycle. In some embodiments, the time window may be periodically repeated, each time window may occur around UL traffic packet arrival time and a length of the time window may be equal to or similar to a range of jitter. In some embodiments, the time window may be overlapped or partially overlapped with an on-duration of the DRX cycle so as to further save power consumption.

With the solution according to embodiments of the present disclosure, dense UL resources may be configured around the UL packet arrival time and thus the UL packet may be transmitted as soon as possible. Further, there is no valid UL resource outside the time window, and thus a terminal device may keep sleeping, which is beneficial for power saving. In addition, an UL transmission may be aligned with an on-duration of a DRX cycle (i.e. DRX active time), and thus a terminal device may be waken up only once for both DL and UL transmissions, which is beneficial for power saving.

Embodiments of the present disclosure may be applied to any suitable scenarios. For example, embodiments of the present disclosure may be implemented for XR. Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

Principles and implementations of the present disclosure will be described in detail below with reference to the figures.

### Example of Communication Network

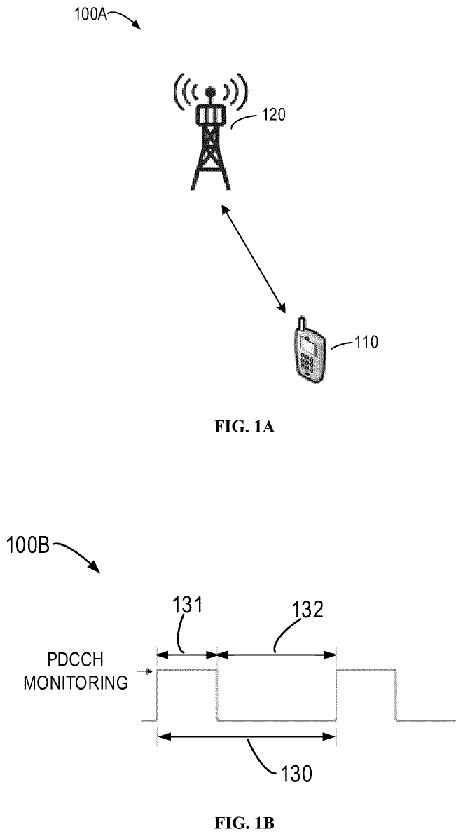

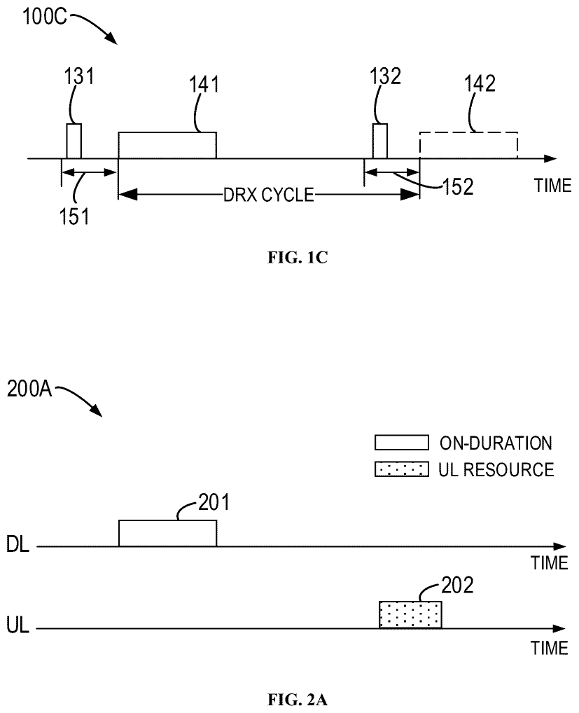

FIG. 1A illustrates a schematic diagram of an example communication network 100A in which some embodiments of the present disclosure can be implemented. As shown in FIG. 1A, the communication network 100A may include a terminal device 110 and a network device 120. In some embodiments, the terminal device 110 may be served by the network device 120. It is to be understood that the numbers of terminal devices and network devices in FIG. 1 are given for the purpose of illustration without suggesting any limitations to the present disclosure. The communication network 100A may include any suitable number of network devices and/or terminal devices adapted for implementing implementations of the present disclosure.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may transmit a configuration of DRX cycle to the terminal device 110. In this case, the terminal device 110 may perform a downlink channel monitoring based on the configuration of DRX cycle. FIG. 1B illustrates a schematic diagram 100B illustrating an example operation in a DRX cycle. As shown in FIG. 1B, a DRX cycle 130 comprises active time 131 (i.e., on-duration) and inactive time 132 (i.e., an opportunity for DRX). The terminal device 110 performs a downlink channel monitoring such as a physical downlink control channel (PDCCH) monitoring only in the active time 131. The inactive time may mean time other than the active time.

A timeline of DRX may mainly depend on the following parameters.
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new uplink (UL) or downlink (DL) transmission for the medium access control (MAC) entity;
drx-LongCycleStartOffset: the Long DRX cycle and drx-StartOffset which defines the subframe where the long and short DRX cycle starts;
drx-ShortCycle (optional): the short DRX cycle;
drx-ShortCycleTimer (optional): the duration a terminal device shall follow the short DRX cycle;
ps-Wakeup (optional): the configuration to start associated drx-onDurationTimer in case DCP is monitored but not detected. DCP refers to DCI with cyclic redundancy check (CRC) scrambled by power saving-radio network temporary identifier (PS-RNTI).

In some scenarios, a network device may transmit a configuration of wake-up signal (WUS) detection to a terminal device. As an example, the WUS is the DCP. In some embodiments, the configuration of WUS detection may comprise an offset (for example, ps-Offset) from a starting time of on-duration and a duration of WUS detection. In this way, a WUS window is configured. One or more WUS occasions may be configured within the WUS window, and each WUS occasion may occupy one or more OFDM symbols. Then the terminal device may perform WUS detection in each WUS occasion based on the configuration of WUS detection, and start on-duration of a DRX cycle when a WUS is detected. FIG. 1C illustrates a schematic diagram 100C illustrating an example operation of on-duration in a DRX cycle with WUS detection.

As shown in FIG. 1C, based on a configuration of a DRX cycle, a terminal device may determine a starting time of on-duration 141, and based on a configuration of WUS detection, the terminal device may start WUS detection at a time earlier than the starting time of the on-duration 141 by an offset 151. When a WUS 131 is detected and the WUS 131 indicates to start the on-duration 141 (i.e., the WUS 131 is a positive WUS), the terminal device may start the on-duration 141 (for example, start the drx-onDurationTimer) at the starting time of the on-duration 141.

Similarly, based on a configuration of a DRX cycle, a terminal device may determine a starting time of on-duration 142, and based on a configuration of WUS detection, the terminal device may start WUS detection at a time earlier than the starting time of the on-duration 142 by an offset 152. When a WUS 132 is detected and the WUS 132 indicates to not start the on-duration 142 (for example, not start the drx-onDurationTimer), the terminal device may keep sleep.

In some scenarios, when UL data becomes available for a logical channel, in other words, when UL packets arrived at a buffer of a terminal device, a BSR may be triggered. The BSR may be transmitted either by a dynamically scheduled physical uplink shared channel (PUSCH) or a configured grant PUSCH. A SR may be triggered by the BSR and is used to request UL scheduling for the transmission of BSR and the pending data. The SR may be transmitted by a physical uplink control channel (PUCCH). Configured grant may be configured to transmit a BSR for XR, which is beneficial for latency reduction because the SR procedure is skipped.

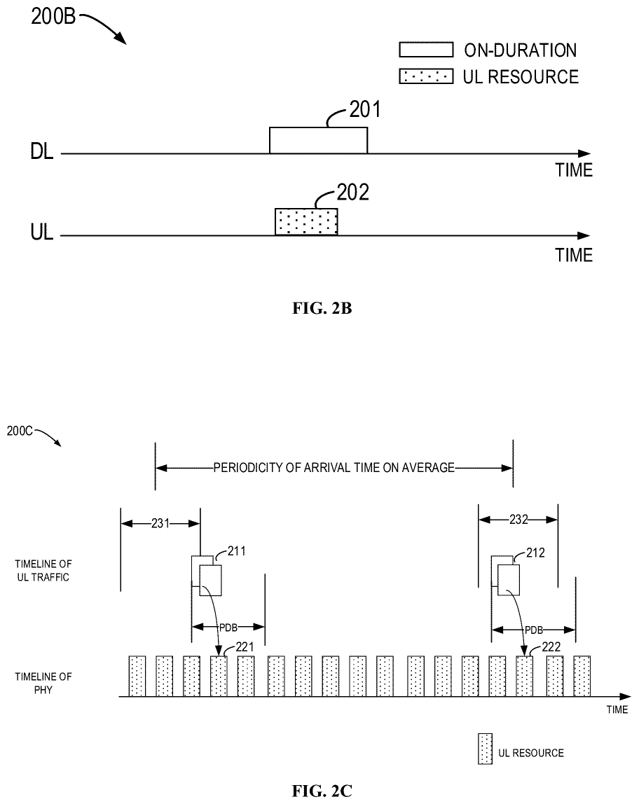

In some scenarios, the UL transmission may be misaligned with an active time of a terminal device, i.e., the UL transmission may be misaligned with an on-duration of a DRX cycle. FIG. 2A illustrates a schematic diagram 200A illustrating an example scenario of a misalignment between DL and UL transmissions. As shown in FIG. 2A, an on-duration 201 of a DRX cycle is not aligned with an UL transmission on an UL resource 202 in time domain. In this case, a terminal device has to wake up twice for a DL reception (e.g., PDCCH monitoring or physical downlink shared channel (PDSCH) reception) and the UL transmission, which may cause increased power consumption.

FIG. 2B illustrates a schematic diagram 200B illustrating an example scenario of an alignment between DL and UL transmissions. As shown in FIG. 2B, an on-duration 201 of a DRX cycle is aligned with an UL transmission on an UL resource 202 in time domain. In this case, a terminal device needs to wake up only once for the DL channel monitoring and the UL transmission, which may cause reduced power consumption. Thus, an alignment between DL and UL transmissions is expected. For the sake of power saving, sparse uplink resources and an alignment with a DL transmission are demanded to avoid frequent wake-up for an UL transmission.

FIG. 2C illustrates a schematic diagram 200C illustrating an example configuration of UL resources considering an effect of jitter. Assuming that a periodicity of arrival time on average is 16.67 ms. It is to be understood that the periodicity may take any other suitable values. As shown in FIG. 2C, packets 211 may arrive at the end of a range of jitter 231 and packets 212 may arrive at the beginning of a range of jitter 232. Due to the effect of jitter and stringent PDB requirement in UL, dense UL resources in time domain may be expected to be configured, which may be beneficial to provide transmission occasions as early as possible after packets arrive. In this case, the packets 211 may be transmitted on an UL resource 221 in a short time after the packets 211 arrive, and the packets 212 may be transmitted on an UL resource 222 in a short time after the packets 212 arrive.

It can be seen that the requirement on dense uplink resources due to the effect of jitter and stringent PDB requirement is contradictory with the requirement on sparse uplink resources due to power saving and an alignment with a DL transmission.

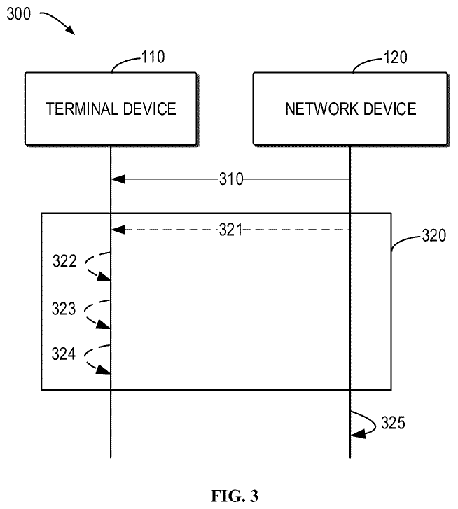

In view of the above, embodiments of the present disclosure provide a solution for an alignment between DL and UL transmissions to overcome the above and other potential issues. With the solution, an alignment between DL and UL transmissions will be achieved while UL packets will be transmitted as early as possible after the UL packets arrive. The solution will be described below with reference to FIGS. 3 to 9.

### Example Implementation of UL Resource Determination

In one aspect, embodiments of the present disclosure provide a solution for UL resource determination. Some example embodiments of UL resource determination will be described with reference to FIG. 3.

FIG. 3 illustrates a schematic diagram illustrating a process 300 of communication according to embodiments of the present disclosure. For the purpose of discussion, the process 300 will be described with reference to FIG. 1. The process 300 may involve the terminal device 110 and the network device 120 as illustrated in FIG. 1.

As shown in FIG. 3, the network device 120 transmits 310, to the terminal device 110, a configuration (for convenience, also referred to as a first configuration herein) for a set of UL resources. The set of UL resources refers to at least one UL resource. In some embodiments, the first configuration may comprise at least one of a periodicity or an offset for the set of UL resources. It is to be understood that the present disclosure does not make limitation for the first configuration.

In some embodiments, the set of UL resources may be configured for SR transmission. In some embodiments, the set of UL resources may be configured for configured grant transmission. In some embodiments, the set of UL resources may be configured for BSR transmission. It is to be understood that the set of UL resources may be configured for any other UL transmissions.

The terminal device 110 determines 320 a time window for the set of UL resources. The time window is associated with a DRX cycle. An UL resource within the time window in the set of UL resources is used for an UL transmission and an UL resource outside the time window in the set of UL resources is invalid for transmission. In this way, an alignment between DL and UL transmissions may be achieved with reduced power consumption. For illustration, some example embodiments for the determination of the time window will be described in connection with Embodiments 1 and 2.

### Embodiment 1

In this embodiment, the time window is configured by the network device 120.

Still with reference to FIG. 3, the network device 120 may transmit 321, to the terminal device 110, a configuration (for convenience, also referred to as a second configuration herein) indicating the time window. In some embodiments, the second configuration may comprise at least one of a duration, a periodicity or an offset of the time window.

In some embodiments, the periodicity of the time window may be the same as a periodicity of the DRX cycle. In some embodiments, the periodicity of the time window and the periodicity of the DRX cycle may be both associated with a periodicity of traffic. For example, the periodicity of the time window and the periodicity of the DRX cycle may be both associated with a FPS (frames per second) of a video stream. For example, for a 60 FPS video steam traffic, the periodicity of the DRX cycle and the periodicity of the time window may both equal to 1/60 second, i.e., approximate 16.67 millisecond.

In some embodiments, the duration of the time window may be indicated in milliseconds or in number of slots or subframes. In some embodiments, the periodicity of the time window may be indicated by an integer or non-integer number of milliseconds or slots or subframes. In some embodiments, the offset of the time window may be indicated by an integer number of milliseconds or slots or subframes or OFDM symbols.

Upon reception of the second configuration, the terminal device 110 may determine 322 the time window based on the second configuration. In some embodiments, the terminal device 110 may determine a time instance (for convenience, also referred to as a first time instance herein) based on a reference time, the periodicity and an index of the time window. In some embodiments, the reference time may be preconfigured by the network device 120 for the terminal device 110. For example, the reference time may be a system frame number (SFN) or a subframe number or a slot number. In some embodiments, the reference time may be predefined. For example, the reference time may be predefined to be 0.

In some embodiments, the first time instance may be determined based on equation (1) below.

$$D = T 0 + n * T 1 \qquad ( 1 )$$

where D denotes the first time instance, T0 denotes the reference time, T1 denotes the periodicity of the time window, and n denotes an index of the time window and n is an integer greater than or equal to 0.

In some embodiments, the first time instance may be determined based on equation (2) below.

$$D = T 0 + ceil ( n * T 1 ) \qquad ( 2 )$$

where D denotes the first time instance, T0 denotes the reference time, T1 denotes the periodicity of the time window, and n denotes an index of the time window and n is an integer greater than or equal to 0.

In some embodiments, the first time instance may be determined based on equation (3) below.

$$D = T 0 + floor ( n * T 1 ) \qquad ( 3 )$$

where D denotes the first time instance, T0 denotes the reference time, T1 denotes the periodicity of the time window, and n denotes an index of the time window and n is an integer greater than or equal to 0.

In some embodiments, the first time instance may be determined based on equation (4) or (5) below.

$$D = ( T 0 + n * T 1 ) mod 1024 \qquad ( 4 )$$

$$D = ( T 0 + n * T 1 ) mod 10240 \qquad ( 5 )$$

where D denotes the first time instance, T0 denotes the reference time, T1 denotes the periodicity of the time window, and n denotes an index of the time window and n is an integer greater than or equal to 0.

In some embodiments, the first time instance may be determined based on equation (6) or (7) below.

$$D = [ T 0 + ceil ( n * T 1 ) ] mod 1024 \qquad ( 6 )$$

$$D = [ T 0 + ceil ( n * T 1 ) ] mod 10240 \qquad ( 7 )$$

where D denotes the first time instance, T0 denotes the reference time, T1 denotes the periodicity of the time window, and n denotes an index of the time window and n is an integer greater than or equal to 0.

In some embodiments, the first time instance may be determined based on equation (8) or (9) below.

$$D = [ T 0 + floor ( n * T 1 ) ] mod 1024 \qquad ( 8 )$$

$$D = [ T 0 + floor ( n * T 1 ) ] mod 10240 \qquad ( 9 )$$

where D denotes the first time instance, T0 denotes the reference time, T1 denotes the periodicity of the time window, and n denotes an index of the time window and n is an integer greater than or equal to 0.

It is to be understood that the equations (1) to (9) are merely examples, and any other suitable ways are also feasible for determination of the first time instance.

Upon determination of the first time instance, the terminal device 110 may determine another time instance (for convenience, also referred to as a second time instance herein) based on the first time instance. In some embodiments, the second time instance may be equal to the first time instance. In some embodiments, the second time instance may be a starting slot or symbol (i.e., the first slot or symbol) after the first time instance. In some embodiments, the second time instance may be a starting slot or symbol (i.e., the first slot or symbol) after the first time instance, the starting slot or symbol comprising an UL resource in the set of UL resources.

Upon determination of the second time instance, the terminal device 110 may determine a starting time of the time window based on the second time instance and the offset of the time window. For example, the time window may start after the offset from the second time instance. It is to be understood that this is merely an example, and the starting time of the time window may be determined in any other suitable ways.

In some embodiments, the offset of the time window may be adaptively modified by a layer 1 (L1) indication. In some embodiments, the offset of the time window may be modified based on a SFN. For example, when a SFN changes from 1023 to 0, the offset of the time window may be adjusted by adding an adjusting value to the offset. The adjusting value may be designed so that the periodicity is kept when a SFN period ends. In some embodiments, the adjusting value may be configured by the network device 120. In some embodiments, the adjusting value may be calculated by the terminal device 110.

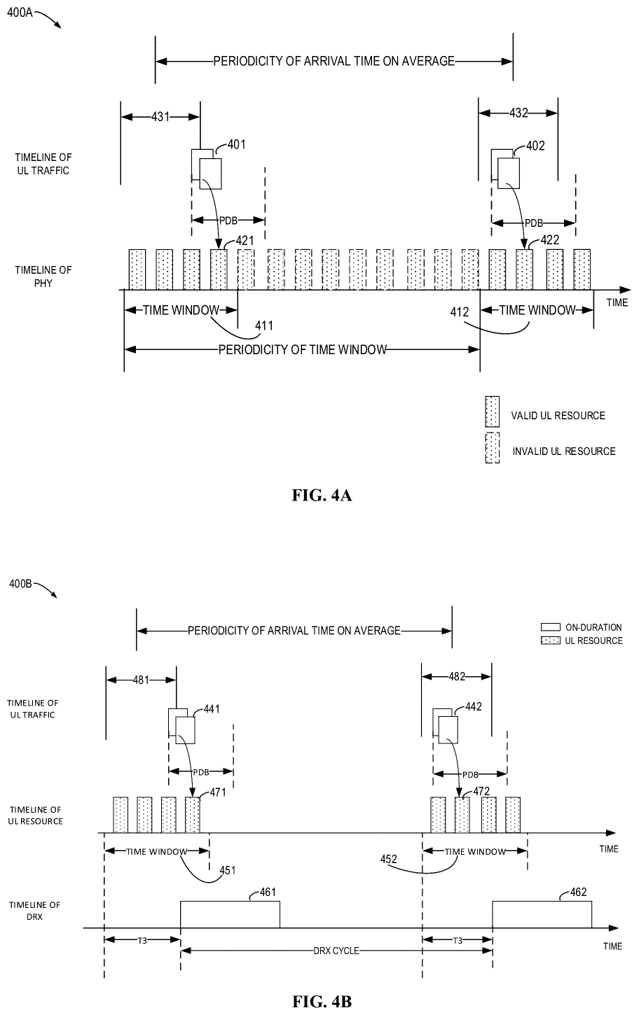

Then the terminal device 110 may determine the time window based on the starting time and the duration of the time window. FIG. 4A illustrates a schematic diagram 400A illustrating an example determination of a time window according to embodiments of the present disclosure. Assuming that a periodicity of arrival time on average is 16.67 ms. It is to be understood that the periodicity may take any other suitable values.

As shown in FIG. 4A, packets 401 may arrive at the end of a range of jitter 431 and packets 402 may arrive at the beginning of a range of jitter 432. Based on a configuration of a time window from the network device 120, the terminal device 110 may determine time windows 411 and 412 periodically repeated. UL resources within the time windows 411 and 412 are valid for UL transmission, and UL resources outside the time windows 411 and 412 are invalid for UL transmission. The time windows 411 and 412 are associated with DRX cycles. In this case, the packets 401 may be transmitted on an UL resource 421 within the time window 411 in a short time after the packets 401 arrive, and the packets 402 may be transmitted on an UL resource 222 within the time window 412 in a short time after the packets 402 arrive. It is to be understood that FIG. 4A is merely for illustration, and is not intended to limit the present disclosure.

In this way, an UL resource may be determined based on a configured time window associated with a DRX cycle, and thus an alignment between DL and UL transmissions may be facilitated and power saving may be improved.

### Embodiment 2

In this embodiment, the time window is determined by the terminal device 110.

Still with reference to FIG. 3, the terminal device 110 may determine 323 a starting time of the time window based on a configuration of the DRX cycle. In some embodiments, the terminal device 110 may determine the starting time of the time window based on a starting time of an on-duration of the DRX cycle and an offset value (for convenience, also referred to as a first offset value herein) configured for the terminal device 110. In some embodiments, the first offset value may be a positive value. In this case, the terminal device 110 may consider that UL resources are valid after the first offset value before the starting time of the on-duration of the DRX cycle. In some embodiments, the first offset value may be a negative value. In this case, the terminal device 110 may consider that UL resources are valid after an absolute value of the first offset value after the starting time of the on-duration of the DRX cycle.

Then the terminal device 110 may determine 324 an ending time of the time window. In some embodiments, the terminal device 110 may determine the ending time of the time window based on a duration of the time window configured for the terminal device 110. In other words, the network device 120 may directly configure the duration of the time window for the terminal device 110.

In some embodiments, the terminal device 110 may determine the ending time of the time window based on another offset value (for convenience, also referred to as a second offset value herein) configured for the terminal device 110 and the starting time of the on-duration of the DRX cycle. For example, the time window may end at the second offset value before the starting time of the on-duration of the DRX cycle. As another example, the time window may end at the second offset value after the starting time of the on-duration of the DRX cycle.

In some embodiments, the terminal device 110 may determine the ending time of the time window based on the second offset value configured for the terminal device 110 and an ending time of the on-duration of the DRX cycle. For example, the time window may end at the second offset value before the ending time of the on-duration of the DRX cycle. As another example, the time window may end at the second offset value after the ending time of the on-duration of the DRX cycle.

In some embodiments, the terminal device 110 may determine the ending time of the time window based on the ending time of the on-duration of the DRX cycle. For example, the time window may end when an on-duration timer expires. As another example, the time window may end when an on-duration timer is stopped.

In some embodiments, the terminal device 110 may determine the ending time of the time window based on a time at which the terminal device 110 gets into inactive time. For example, the time window may end when both an on-duration timer and an inactivity timer expire. As another example, the time window may end when both an on-duration timer and an inactivity timer are stopped.

Thereby, the terminal device 110 may determine the time window based on the starting time and the ending time of the time window. FIG. 4B illustrates a schematic diagram 400B illustrating an example determination of a time window according to embodiments of the present disclosure. Assuming that a periodicity of arrival time on average is 16.67 ms. It is to be understood that the periodicity may take any other suitable values.

As shown in FIG. 4B, packets 441 may arrive at the end of a range of jitter 481 and packets 442 may arrive at the beginning of a range of jitter 482. Based on a starting time of an on-duration 461 of a DRX cycle and an offset value T3 (i.e., the first offset value), the terminal device 110 may determine a starting time of a time window 451. Assuming that the second offset value is configured by the network device 120. In this example, the terminal device may determine an ending time of the time window 451 at the second offset value after the starting time of the on-duration 461. Based on a starting time of an on-duration 462 of another DRX cycle and the offset value T3 (i.e., the first offset value), the terminal device 110 may determine a starting time of a time window 452. In this example, the terminal device may determine an ending time of the time window 452 at the second offset value after the starting time of the on-duration 462.

As shown in FIG. 4B, UL resources within the time windows 451 and 452 are valid for UL transmission, and UL resources outside the time windows 451 and 452 are invalid for UL transmission. The time windows 451 and 452 are associated with DRX cycles. In this case, the packets 441 may be transmitted on an UL resource 471 within the time window 451 in a short time after the packets 441 arrive, and the packets 442 may be transmitted on an UL resource 472 within the time window 452 in a short time after the packets 442 arrive. It is to be understood that FIG. 4B is merely for illustration, and is not intended to limit the present disclosure.

In this embodiment, for a DRX configuration, a set of UL resources may be associated with each DRX cycle. The set of UL resources may occur in a time window, the time window occurring around UL traffic packet arrival time and a length of the time window being equal to or similar to the range of jitter. Dense UL resources may be configured within the time window and there is no valid UL resource outside the time window. For better DL and UL alignment, the time window may start before the starting time of the on-duration, and may end no later than the ending time of the on-duration.

In this way, an UL resource may be determined based on a time window determined from a starting and ending of a DRX cycle, and thus an alignment between DL and UL transmissions may also be facilitated and power saving may also be improved.

So far, the determination 320 of the time window by the terminal device 110 is described in connection with Embodiments 1 and 2. As shown in FIG. 3, the network device 120 may also determine 325 the time window. The procedure of the determination 325 is similar to that of the determination 320, and thus is not repeated here for concise.

### Example Implementation of On-Duration Operation

In another aspect, embodiments of the present disclosure provide a solution for an on-duration operation. In the context of the present disclosure, the on-duration operation may comprise a starting of an on-duration timer and a monitoring of a DL transmission. In other words, embodiments of the present disclosure provide a wake-up mechanism (also referred to as an UL triggered DRX herein) based on an UL transmission.

In the solution, a set of UL resources may be configured as being associated with a DRX cycle (also referred to as an associated DRX cycle herein). Thus, whether to start an on-duration timer may be determined based on whether an UL transmission is performed on an UL resource in the set of UL resources. Further, how to perform a DL monitoring may be determined based on an UL transmission and WUS detection. Some example embodiments of the on-duration operation will be described in connection with Embodiments 3 to 5.

### Embodiment 3

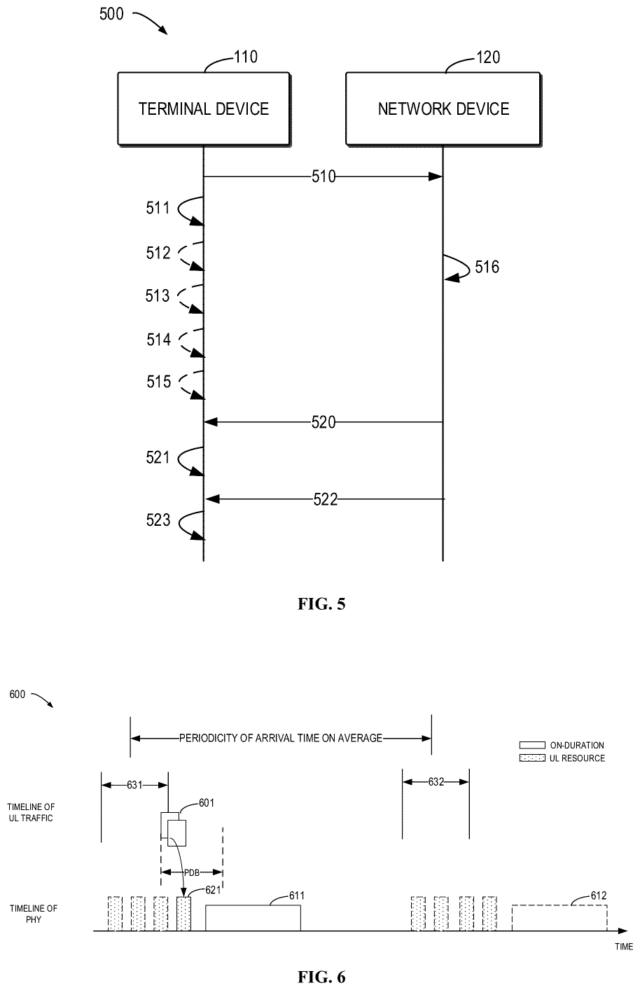

In this embodiment, the on-duration operation is only triggered by an UL transmission. The detailed description will be given with reference to FIGS. 5 and 6.

FIG. 5 illustrates a schematic diagram illustrating another process 500 of communication according to embodiments of the present disclosure. For the purpose of discussion, the process 500 will be described with reference to FIG. 1. The process 500 may involve the terminal device 110 and the network device 120 as illustrated in FIG. 1.

As shown in FIG. 5, the terminal device 110 may perform 510 an UL transmission to the network device 120. For example, the terminal device 110 may transmit a SR or BSR to the network device 120 on an UL resource within the time window according to embodiments of the present disclosure.

In response to performing the UL transmission, the terminal device 110 may start 511 an on-duration timer for an associated DRX cycle. In some embodiments where the UL resource is determined as described in Embodiment 1, all the UL resources within the time window are associated with the next DRX cycle with respect to the time window. In this case, the associated DRX cycle is the next DRX cycle with respect to the time window. In some embodiments where the UL resource is determined as described in Embodiment 2, all the UL resources within the time window are configured based on a timing of a particular DRX cycle (i.e., the current DRX cycle with respect to the time window). In this case, the associated DRX cycle is the current DRX cycle with respect to the time window.

In some embodiments, if the terminal device 110 does not perform the UL transmission on the UL resource within the time window, the terminal device 110 may not start 512 the on-duration timer for the associated DRX cycle.

Still with reference to FIG. 5, in some embodiments, the terminal device 110 may determine 513 whether the UL transmission is performed on the UL resource within the time window at a time earlier than a starting time of an on-duration of the DRX cycle by a time duration shorter than a threshold duration. In other words, the terminal device 110 may determine whether the UL transmission is performed after or before the threshold duration prior to the starting time of the on-duration. In some embodiments, the threshold duration may be preconfigured. In some embodiments, the threshold duration may be predefined. For example, the threshold duration may be 4 milliseconds. It is to be understood that the threshold duration may adopt any other suitable values.

In some embodiments, if the UL transmission is performed before the threshold duration prior to the starting time of the on-duration, the terminal device 110 may start the on-duration timer. In some embodiments, if the UL transmission is performed after the threshold duration prior to the starting time of the on-duration, the terminal device 110 may not start 514 the on-duration timer. In some embodiments, if the UL transmission is performed after the threshold duration prior to the starting time of the on-duration, the terminal device 110 may start 515 the on-duration timer based on a time offset configured for the terminal device 110 and an end of the UL transmission. For example, the terminal device 110 may start the on-duration timer after a time offset from the end of the UL transmission. In other words, the terminal device 110 may start the on-duration timer at a time instance later than the original starting time of the on-duration. In this case, the starting time of the on-duration is dependent on the UL transmission.

FIG. 6 illustrates a schematic diagram 600 illustrating an example starting of an on-duration timer according to embodiments of the present disclosure. Assuming that a periodicity of arrival time on average is 16.67 ms. It is to be understood that the periodicity may take any other suitable values.

As shown in FIG. 6, packets 601 may arrive at the end of a range of jitter 631. In this example, the packets 601 may be transmitted on an UL resource 621 within a time window. In response to the transmission of the packets 601, the terminal device 110 may start an on-duration timer for an on-duration 611 of a DRX cycle. The similar operation also applies to the next range of jitter 632 and the next on-duration 612. It is to be understood that FIG. 6 is merely for illustration, and is not intended to limit the present disclosure.

With reference to FIG. 5, upon reception of the UL transmission, the network device 120 performs 516 operations similar to the operations described in connection with 511 to 515. Its details are not repeated here for concise.

In some embodiments, the network device 120 may also configure a WUS monitoring window for the terminal device 110. As shown in FIG. 5, the network device 120 may transmit 520 a WUS to the terminal device 110. Accordingly, the terminal device 110 may perform a monitoring of a WUS (i.e., WUS detection). In some embodiments, when the UL transmission is performed, the terminal device 110 may start the on-duration timer and stop 521 the monitoring of the WUS. In other words, the UL transmission has a priority higher than that of the WUS. When the UL transmission is performed, the terminal device 110 may ignore whether and what the WUS is detected.

In some embodiments, the UL transmission may be associated with a search space set group (SSSG) (for convenience, also referred to as a first SSSG herein), and the WUS may be associated with another SSSG (for convenience, also referred to as a second SSSG herein). In some embodiments where the on-duration timer is only triggered by the UL transmission, the network device 120 may perform 522 a DL transmission in the on-duration of the DRX cycle based on the first SSSG. Accordingly, the terminal device 110 may perform 523 a DL monitoring in the on-duration of the DRX cycle based on the first SSSG.

In some embodiments, the first SSSG may not comprise a downlink control information (DCI) format for DL scheduling (for example, DCI format 1-0, 1-1 or 1-2). In some embodiments, if the first SSSG comprises the DCI format for DL scheduling, the terminal device 110 may not perform the DL monitoring on the DCI format for DL scheduling in the first SSSG.

In this way, an on-duration operation triggered by only an UL transmission is described.

### Embodiment 4

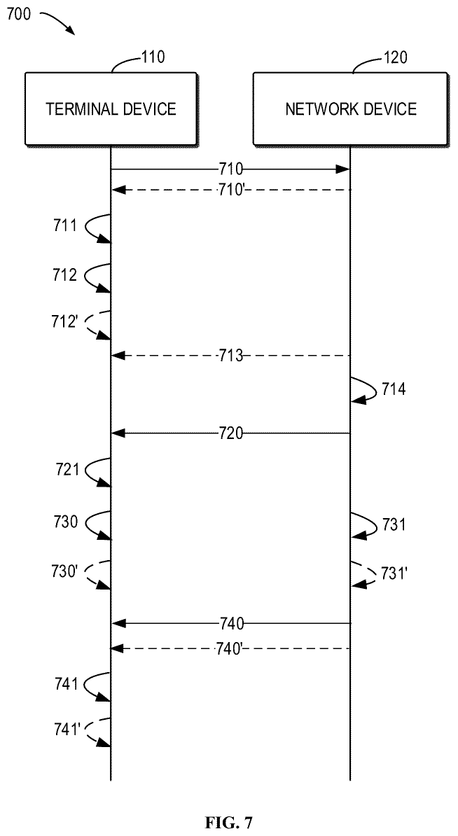

In this embodiment, the on-duration operation is jointly triggered by an UL transmission and a WUS. The detailed description will be given with reference to FIGS. 7 and 8.

FIG. 7 illustrates a schematic diagram illustrating still another process 700 of communication according to embodiments of the present disclosure. For the purpose of discussion, the process 700 will be described with reference to FIG. 1. The process 700 may involve the terminal device 110 and the network device 120 as illustrated in FIG. 1.

As shown in FIG. 7, the terminal device 110 may perform 710 an UL transmission to the network device 120. For example, the terminal device 110 may transmit a SR or BSR to the network device 120 on an UL resource within the time window according to embodiments of the present disclosure.

In some embodiments, the network device 120 may transmit 710′ a WUS to the terminal device 110. In some embodiments, the WUS may indicate to start an on-duration of a DRX cycle, i.e., to start an on-duration timer. In this case, the WUS is a positive WUS and has a first value. The positive WUS may also be interpreted as a positive acknowledgment for the UL transmission performed by the terminal device 110. In some embodiments, the WUS may indicate to not start an on-duration of a DRX cycle, i.e., to not start an on-duration timer. In this case, the WUS is a negative WUS and has a second value different from the first value. The negative WUS may also be interpreted as a negative acknowledgment for the UL transmission performed by the terminal device 110. Of course, the network device 120 may also not transmit a WUS to the terminal device 110.

In response to performing the UL transmission, the terminal device 110 may determine 711 whether a WUS is received by the terminal device 110.

### 1. No WUS Received

In some embodiments, if no WUS is received, the terminal device 110 may not start 712 the on-duration timer for an associated DRX cycle (for convenience, also referred to as a first operation herein). In some alternative embodiments, if no WUS is received, the terminal device 110 may start 712′ the on-duration timer for the associated DRX cycle (for convenience, also referred to as a second operation herein).

In some embodiments, the network device 120 may transmit 713, to the terminal device 110, an indication indicating the first operation or the second operation. For example, the indication may be received from an RRC signaling from the network device 120. Of course, any other suitable ways are also feasible. Based on the indication, the terminal device 110 may perform the first operation or the second operation accordingly, i.e., start or not start the on-duration timer.

Similar to that described in Embodiment 3, the associated DRX cycle may be the next DRX cycle with respect to the time window if an UL resource for the UL transmission is determined as described in Embodiment 1, and may be the current DRX cycle with respect to the time window if the UL resource for the UL transmission is determined as described in Embodiment 2. Other details of the associated DRX cycle are not repeated here for concise.

FIG. 8 illustrates a schematic diagram 800 illustrating another example starting of an on-duration timer according to embodiments of the present disclosure. Assuming that a periodicity of arrival time on average is 16.67 ms. It is to be understood that the periodicity may take any other suitable values. As shown in FIG. 8, packets 801 may arrive at the end of a range of jitter 841. In this example, the packets 801 may be transmitted on an UL resource 821 within a time window. In response to the transmission of the packets 801, if the terminal device 110 does not receive a WUS at a WUS occasion 831, the terminal device 110 may not start an on-duration timer for an on-duration 811 of a DRX cycle. It is to be understood that FIG. 8 is merely for illustration, and is not intended to limit the present disclosure.

Still with reference to FIG. 7, upon reception of the UL transmission, the network device 120 may perform 714 operations similar to the operations described in connection with 711, 712 and 712′. Its details are not repeated here for concise.

Similar to that described in Embodiment 3, the UL transmission may be associated with the first SSSG, and the WUS may be associated with the second SSSG. In some embodiments where the on-duration timer is triggered by the UL transmission with no WUS received, the network device 120 may perform 720 a DL transmission in the on-duration of the DRX cycle based on the first SSSG. Accordingly, the terminal device 110 may perform 721 a DL monitoring in the on-duration of the DRX cycle based on the first SSSG.

In some embodiments, the first SSSG may not comprise a DCI format for DL scheduling (for example, DCI format 1-0, 1-1 or 1-2). In some embodiments, if the first SSSG comprises the DCI format for DL scheduling, the terminal device 110 may not perform the DL monitoring on the DCI format for DL scheduling in the first SSSG.

### 2. WUS Received

In some embodiments, if the positive WUS is received, the terminal device 110 may start 730 the on-duration timer for the associated DRX cycle. Accordingly, upon transmission of the positive WUS, the network device 120 may also start 731 the on-duration timer for the associated DRX cycle.

In some embodiments, if the negative WUS is received, the terminal device 110 may not start 730′ the on-duration timer for the associated DRX cycle. Accordingly, upon transmission of the negative WUS, the network device 120 may also not start 731′ the on-duration timer for the associated DRX cycle.

Continue to with reference to FIG. 8, in response to the transmission of the packets 801, if the terminal device 110 receives a positive WUS at the WUS occasion 831, the terminal device 110 may start the on-duration timer for the on-duration 811 of the DRX cycle. If the terminal device 110 receives a negative WUS at the WUS occasion 831, the terminal device 110 may not start the on-duration timer for the on-duration 811 of the DRX cycle. It is to be understood that FIG. 8 is merely for illustration, and is not intended to limit the present disclosure.

In some embodiments where the on-duration timer is jointly triggered by the UL transmission and the positive WUS, the network device 120 may perform 740 a DL transmission in the on-duration of the DRX cycle based on both the first SSSG and the second SSSG. In some embodiments, the first SSSG may not comprise a DCI format for DL scheduling (for example, DCI format 1-0, 1-1 or 1-2). In some embodiments, if the first SSSG comprises the DCI format for DL scheduling, the network device 120 may not perform the DL transmission on the DCI format for DL scheduling in the first SSSG. In some embodiments, the second SSSG may not comprise a DCI format for UL scheduling (for example, DCI format 0-0, 0-1 or 0-2). In some embodiments, if the second SSSG comprises the DCI format for UL scheduling, the network device 120 may not perform the DL transmission on the DCI format for UL scheduling in the second SSSG.

In some alternative embodiments, the network device 120 may perform 740′ the DL transmission in the on-duration of the DRX cycle based on a predetermined SSSG, e.g., a default SSSG. In some embodiments, the predetermined SSSG may be a union of the first and second SSSGs. Of course, the predetermined SSSG may be a SSSG different from the first and second SSSGs.

Accordingly, in some embodiments where the on-duration timer is jointly triggered by the UL transmission and the positive WUS, the terminal device 110 may perform 741 a DL monitoring in the on-duration of the DRX cycle based on both the first SSSG and the second SSSG. In some embodiments, the first SSSG may not comprise a DCI format for DL scheduling (for example, DCI format 1-0, 1-1 or 1-2). In some embodiments, if the first SSSG comprises the DCI format for DL scheduling, the terminal device 110 may not perform the DL monitoring on the DCI format for DL scheduling in the first SSSG. In some embodiments, the second SSSG may not comprise a DCI format for UL scheduling (for example, DCI format 0-0, 0-1 or 0-2). In some embodiments, if the second SSSG comprises the DCI format for UL scheduling, the terminal device 110 may not perform the DL monitoring on the DCI format for UL scheduling in the second SSSG.

In some alternative embodiments, the terminal device 110 may perform 741′ the DL monitoring in the on-duration of the DRX cycle based on the predetermined SSSG.

In this way, an on-duration operation triggered by both an UL transmission and a WUS is described.

### Embodiment 5

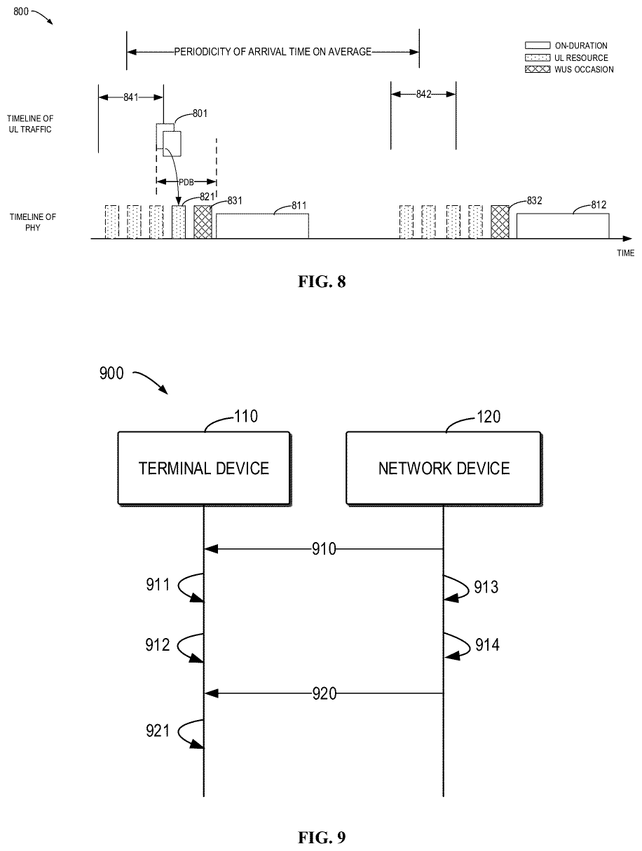

In this embodiment, the on-duration operation is triggered by only a WUS. The detailed description will be given with reference to FIGS. 8 and 9.

FIG. 9 illustrates a schematic diagram illustrating still another process 900 of communication according to embodiments of the present disclosure. For the purpose of discussion, the process 900 will be described with reference to FIG. 1. The process 900 may involve the terminal device 110 and the network device 120 as illustrated in FIG. 1.

As shown in FIG. 9, the network device 120 may transmit 910 a WUS to the terminal device 110. In some embodiments, the WUS may indicate to start an on-duration of a DRX cycle, i.e., to start an on-duration timer. In this case, the WUS is a positive WUS and has a first value. The positive WUS may also be interpreted as a positive acknowledgment for the UL transmission performed by the terminal device 110. In some embodiments, the WUS may indicate to not start an on-duration of a DRX cycle, i.e., to not start an on-duration timer. In this case, the WUS is a negative WUS and has a second value different from the first value. The negative WUS may also be interpreted as a negative acknowledgment for the UL transmission performed by the terminal device 110.

The terminal device 110 may determine 911 whether no UL transmission is performed on the UL resource within the time window and the positive WUS is received. If no UL transmission is performed on the UL resource within the time window and the positive WUS is received, the terminal device 110 may start 912 the on-duration timer for the associated DRX cycle. In some embodiments, if no UL transmission is performed on the UL resource within the time window and the negative WUS is received, the terminal device 110 may not start the on-duration timer for the associated DRX cycle.

Accordingly, the network device 120 may determine 913 whether no UL transmission is received on the UL resource within the time window and the positive WUS is transmitted. If no UL transmission is received on the UL resource within the time window and the positive WUS is transmitted, the network device 120 may start 914 the on-duration timer for the associated DRX cycle. In some embodiments, if no UL transmission is received on the UL resource within the time window and the negative WUS is transmitted, the network device 120 may not start the on-duration timer for the associated DRX cycle.

Continue to with reference to FIG. 8, as no packets arrive in a range of jitter 842, no UL transmission is performed on any UL resource within time window. In this case, if the terminal device 110 receives a positive WUS at a WUS occasion 832, the terminal device 110 may start an on-duration timer for an on-duration 812 of a DRX cycle. If the terminal device 110 receives a negative WUS at the WUS occasion 832, the terminal device 110 may not start the on-duration timer for the on-duration 812 of the DRX cycle. It is to be understood that FIG. 8 is merely for illustration, and is not intended to limit the present disclosure.

In some embodiments where the on-duration timer is triggered by only the WUS, the network device 120 may perform 920 a DL transmission in the on-duration of the DRX cycle based on the second SSSG associated with the WUS. In some embodiments, the second SSSG may not comprise a DCI format for UL scheduling (for example, DCI format 0-0, 0-1 or 0-2). In some embodiments, if the second SSSG comprises the DCI format for UL scheduling, the network device 120 may not perform the DL transmission on the DCI format for UL scheduling in the second SSSG.

Accordingly, in some embodiments where the on-duration timer is triggered by only the WUS, the terminal device 110 may perform 921 a DL monitoring in the on-duration of the DRX cycle based on the second SSSG. In some embodiments, the second SSSG may not comprise a DCI format for UL scheduling (for example, DCI format 0-0, 0-1 or 0-2). In some embodiments, if the second SSSG comprises the DCI format for UL scheduling, the terminal device 110 may not perform the DL monitoring on the DCI format for UL scheduling in the second SSSG.

In this way, an on-duration operation triggered by only a WUS is described.

It can be seen that according to embodiments of the present disclosure, a UL triggered DRX may be achieved. For some applications, a DL transmission may be triggered by a UL transmission. For instance, for some VR applications, after a pose or control information transmitted in UL, an application server may transmit a video frame in DL based on the pose or control information. Thus, the UL triggered DRX may be beneficial for this kind of applications. Further, for traffic with stringent requirement for UL PDB and large UL packet size, the UL triggered DRX may be beneficial to satisfy the PDB requirement. In addition, for the case that DL and UL traffic are well aligned, e.g., by an application function (AF), the UL triggered DRX may be beneficial for power saving and overhead or complexity reduction since DL WUS may be skipped.

### Example Implementation of Methods

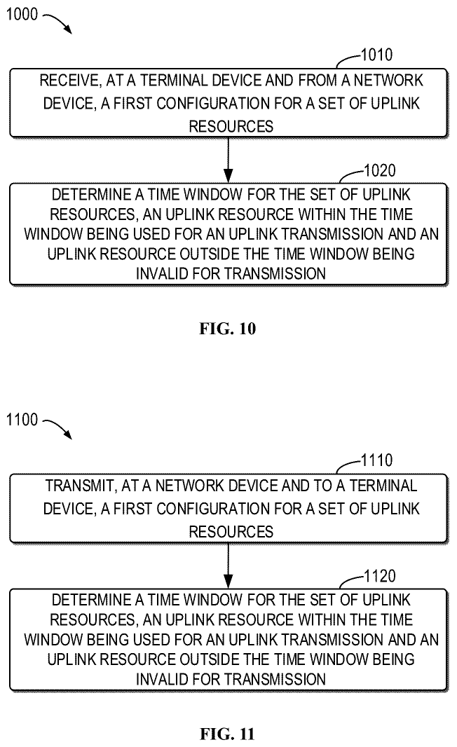

Accordingly, embodiments of the present disclosure provide methods of communication implemented at a terminal device and a network device. These methods will be described below with reference to FIGS. 10 to 11.

FIG. 10 illustrates an example method 1000 of communication implemented at a terminal device in accordance with some embodiments of the present disclosure. For example, the method 1000 may be performed at the terminal device 110 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the terminal device 110 receives, from the network device 120, a first configuration for a set of uplink resources.

At block 1020, the terminal device 110 determines a time window for the set of uplink resources, the time window being associated with a DRX cycle, an uplink resource within the time window in the set of uplink resources being used for an uplink transmission and an uplink resource outside the time window in the set of uplink resources being invalid for transmission. In some embodiments, the uplink transmission may comprise at least one of a SR, a BSR, or a configured grant UL transmission.

In some embodiments, the terminal device 110 may receive, from the network device 120, a second configuration indicating the time window, and determine the time window based on the second configuration. In some embodiments, the second configuration may comprise at least one of a duration, a periodicity or an offset of the time window. In some embodiments, the periodicity of the time window may be the same as a periodicity of the DRX cycle.

In some embodiments, the terminal device 110 may determine a first time instance based on a reference time, the periodicity and an index of the time window; determine a second time instance based on the first time instance; determine a starting time of the time window based on the second time instance and the offset; and determine the time window based on the starting time and the duration.

In some embodiments, the terminal device 110 may determine a starting time of the time window based on a starting time of an on-duration of the DRX cycle and a first offset value configured for the terminal device; and determine an ending time of the time window based on at least one of the following: a duration of the time window configured for the terminal device; a second offset value configured for the terminal device and the starting time or an ending time of the on-duration of the DRX cycle; the ending time of the on-duration of the DRX cycle; or a time at which the terminal device gets into inactive time.

In some embodiments, if the uplink transmission is performed on the uplink resource within the time window, the terminal device 110 may start an on-duration timer for an associated DRX cycle. In some embodiments, the terminal device 110 may stop a monitoring of a wake-up signal.

In some embodiments, if the uplink transmission is performed on the uplink resource within the time window at a time earlier than a starting time of an on-duration of the DRX cycle by a time duration shorter than a threshold duration, the terminal device 110 may start no on-duration timer for the DRX cycle, or start an on-duration timer based on an end of the uplink transmission and a time offset configured for the terminal device.

In these embodiments, the terminal device 110 may perform a monitoring in an on-duration of the DRX cycle based on a first SSSG associated with the uplink transmission. In some embodiments, the first SSSG comprises no DCI format for downlink scheduling. In some embodiments, if the first SSSG comprises a DCI format for downlink scheduling, the terminal device 110 may perform no monitoring on the DCI format for downlink scheduling in the first SSSG.

In some embodiments, if the uplink transmission is performed on the uplink resource within the time window and no wake-up signal is received, the terminal device 110 may perform one of the following: a first operation of starting no on-duration timer for an associated DRX cycle; or a second operation of starting an on-duration timer for the associated DRX cycle. In some embodiments, the terminal device 110 may receive, from the network device 120, an indication indicating the first operation or the second operation.

In these embodiments, the terminal device 110 may perform a monitoring in an on-duration of the DRX cycle based on a first SSSG associated with the uplink transmission. In some embodiments, the first SSSG comprises no DCI format for downlink scheduling. In some embodiments, if the first SSSG comprises a DCI format for downlink scheduling, the terminal device 110 may perform no monitoring on the DCI format for downlink scheduling in the first SSSG.

In some embodiments, if the uplink transmission is performed on the uplink resource within the time window and a wake-up signal having a first value is received, the terminal device 110 may start an on-duration timer for an associated DRX cycle. In some embodiments, if the uplink transmission is performed on the uplink resource within the time window and a wake-up signal having a second value is received, the terminal device 110 may start no on-duration timer for the associated DRX cycle. In some embodiments, the first value indicates a starting of the on-duration timer or a positive acknowledgement of the uplink transmission, and the second value indicates no starting of the on-duration timer or a negative acknowledgement of the uplink transmission.

In these embodiments, the terminal device 110 may perform a monitoring in an on-duration of the DRX cycle based on a first search space set group associated with the uplink transmission and a second search space set group associated with the wake-up signal; or perform the monitoring in the on-duration of the DRX cycle based on a predetermined search space set group. In some embodiments, the first SSSG comprises no DCI format for downlink scheduling. In some embodiments, if the first SSSG comprises a DCI format for downlink scheduling, the terminal device 110 may perform no monitoring on the DCI format for downlink scheduling in the first SSSG. In some embodiments, the second SSSG comprises no DCI format for uplink scheduling. In some embodiments, if the second SSSG comprises a DCI format for uplink scheduling, the terminal device 110 may perform no monitoring on the DCI format for uplink scheduling in the second SSSG.

In some embodiments, if no uplink transmission is performed on the uplink resource within the time window and a wake-up signal indicating a starting of an on-duration timer for an associated DRX cycle is received, the terminal device 110 may start the on-duration timer for the associated DRX cycle. In these embodiments, the terminal device 110 may perform a monitoring in an on-duration of the DRX cycle based on a second search space set group associated with the wake-up signal. In some embodiments, the second SSSG comprises no DCI format for uplink scheduling. In some embodiments, if the second SSSG comprises a DCI format for uplink scheduling, the terminal device 110 may perform no monitoring on the DCI format for uplink scheduling in the second SSSG.

In some embodiments, the associated DRX cycle is the next DRX cycle or the current DRX cycle with respect to the time window.

With the method of FIG. 10, an UL resource may be determined based on a time window associated with a DRX cycle, and a UL triggered DRX may be achieved. Thus, an alignment between DL and UL transmissions may be facilitated and power saving may be improved.

FIG. 11 illustrates an example method 1100 of communication implemented at a network device in accordance with some embodiments of the present disclosure. For example, the method 1100 may be performed at the network device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the network device 120 transmits, to the terminal device 110, a first configuration for a set of uplink resources.

At block 1120, the network device 120 determines a time window for the set of uplink resources, the time window being associated with a DRX cycle, an uplink resource within the time window in the set of uplink resources being used for an uplink transmission and an uplink resource outside the time window in the set of uplink resources being invalid for transmission. In some embodiments, the uplink transmission may comprise at least one of a SR, a BSR, or a configured grant UL transmission.

In some embodiments, the network device 120 may transmit, to the terminal device 110, a second configuration indicating the time window; and determine the time window based on the second configuration. In some embodiments, the second configuration may comprise at least one of a duration, a periodicity or an offset of the time window. In some embodiments, the periodicity of the time window may be the same as a periodicity of the DRX cycle.

In some embodiments, the network device 120 may determine a first time instance based on a reference time, the periodicity and an index of the time window; determine a second time instance based on the first time instance; determine a starting time of the time window based on the second time instance and the offset; and determine the time window based on the starting time and the duration.

In some embodiments, the network device 120 may determine a starting time of the time window based on a starting time of an on-duration of the DRX cycle and a first offset value configured for the terminal device; and determine an ending time of the time window based on at least one of the following: a duration of the time window configured for the terminal device; a second offset value configured for the terminal device and the starting time or an ending time of the on-duration of the DRX cycle; the ending time of the on-duration of the DRX cycle; or a time at which the terminal device gets into inactive time.

In some embodiments, if the uplink transmission is performed on the uplink resource within the time window, the network device 120 may start an on-duration timer for an associated DRX cycle.

In some embodiments, if the uplink transmission is performed on the uplink resource within the time window at a time earlier than a starting time of an on-duration of the DRX cycle by a time duration shorter than a threshold duration, the network device 120 may start no on-duration timer for the DRX cycle; or start an on-duration timer based on an end of the uplink transmission and a time offset configured for the terminal device.

In some embodiments, if the uplink transmission is performed on the uplink resource within the time window and that no wake-up signal is received by the terminal device, the network device 120 may perform one of the following: a first operation of starting no on-duration timer for an associated DRX cycle; or a second operation of starting an on-duration timer for the associated DRX cycle. In some embodiments, the network device 120 may transmit, to the terminal device 110, an indication indicating the first operation or the second operation.

In these embodiments, the network device 120 may perform a downlink transmission in an on-duration of the DRX cycle based on a first SSSG associated with the uplink transmission. In some embodiments, the first SSSG comprises no DCI format for downlink scheduling. In some embodiments, if the first SSSG comprises a DCI format for downlink scheduling, the network device 120 may perform no transmission of the DCI format for downlink scheduling in the first SSSG.

In some embodiments, if the uplink transmission is performed on the uplink resource within the time window and that a wake-up signal having a first value is transmitted, the network device 120 may start an on-duration timer for an associated DRX cycle. In some embodiments, if the uplink transmission is performed on the uplink resource within the time window and that a wake-up signal having a second value is transmitted, the network device 120 may start no on-duration timer for the associated DRX cycle. In some embodiments, the first value indicates a starting of the on-duration timer or a positive acknowledgement of the uplink transmission, and the second value indicates no starting of the on-duration timer or a negative acknowledgement of the uplink transmission.

In these embodiments, the network device 120 may perform a downlink transmission in an on-duration of the DRX cycle based on a first search space set group associated with the uplink transmission and a second search space set group associated with the wake-up signal. In some alternative embodiments, the network device 120 may perform a downlink transmission in the on-duration of the DRX cycle based on a predetermined search space set group.

In some embodiments, the first SSSG comprises no downlink control information (DCI) format for downlink scheduling. In some embodiments, if the first SSSG comprises a DCI format for downlink scheduling, performing no transmission of the DCI format for downlink scheduling in the first SSSG. In some embodiments, the second SSSG comprises no DCI format for uplink scheduling. In some embodiments, if the second SSSG comprises a DCI format for uplink scheduling, performing no transmission of the DCI format for uplink scheduling in the second SSSG.

In some embodiments, if no uplink transmission is performed on the uplink resource within the time window and that a wake-up signal indicating a starting of an on-duration timer for an associated DRX cycle is transmitted, the network device 120 may start the on-duration timer for the associated DRX cycle.

In these embodiments, the network device 120 may perform a downlink transmission in an on-duration of the DRX cycle based on a second SSSG associated with the wake-up signal. In some embodiments, the second SSSG comprises no DCI format for uplink scheduling. In some embodiments, if the second SSSG comprises a DCI format for uplink scheduling, performing no transmission of the DCI format for uplink scheduling in the second SSSG.

In some embodiments, the associated DRX cycle is the next DRX cycle or the current DRX cycle with respect to the time window.

With the method of FIG. 11, an UL resource may be determined based on a time window associated with a DRX cycle, and a UL triggered DRX may be achieved. Thus, an alignment between DL and UL transmissions may be facilitated and power saving may be improved.

### Example Implementation of Device and Apparatus

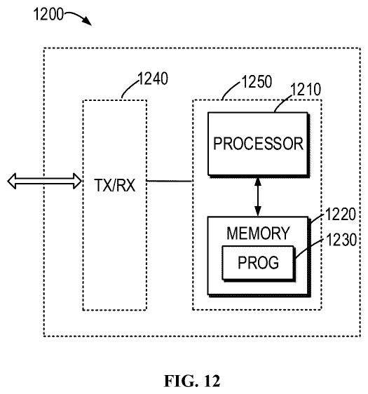

FIG. 12 is a simplified block diagram of a device 1200 that is suitable for implementing embodiments of the present disclosure. The device 1200 can be considered as a further example implementation of the terminal device 110 or the network device 120 as shown in FIG. 1. Accordingly, the device 1200 can be implemented at or as at least a part of the terminal device 110 or the network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the cNB/gNB, Un interface for communication between the eNB/gNB and a relay node (RN), or Uu interface for communication between the cNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises circuitry configured to: receive, from a network device, a first configuration for a set of uplink resources; and determine a time window for the set of uplink resources, the time window being associated with a DRX cycle, an uplink resource within the time window in the set of uplink resources being used for an uplink transmission and an uplink resource outside the time window in the set of uplink resources being invalid for transmission, wherein the uplink transmission comprises at least one of a SR, a BSR, or a configured grant UL transmission.

In some embodiments, the circuitry may be configured to determine the time window by: receiving, from the network device, a second configuration indicating the time window; and determining the time window based on the second configuration. In some embodiments, the second configuration comprises at least one of a duration, a periodicity or an offset of the time window. In some embodiments, the periodicity of the time window is the same as a periodicity of the DRX cycle.

In some embodiments, the circuitry may be configured to determine the time window based on the second configuration by: determining a first time instance based on a reference time, the periodicity and an index of the time window; determining a second time instance based on the first time instance; determining a starting time of the time window based on the second time instance and the offset; and determining the time window based on the starting time and the duration.

In some embodiments, the circuitry may be configured to determine the time window by: determining a starting time of the time window based on a starting time of an on-duration of the DRX cycle and a first offset value configured for the terminal device; and determining an ending time of the time window based on at least one of the following: a duration of the time window configured for the terminal device; a second offset value configured for the terminal device and the starting time or an ending time of the on-duration of the DRX cycle; the ending time of the on-duration of the DRX cycle; or a time at which the terminal device gets into inactive time.

In some embodiments, the circuitry may be further configured to: in accordance with a determination that the uplink transmission is performed on the uplink resource within the time window, start an on-duration timer for an associated DRX cycle. In some embodiments, the circuitry may be further configured to stop a monitoring of a wake-up signal.

In some embodiments, the circuitry may be further configured to: in accordance with a determination that the uplink transmission is performed on the uplink resource within the time window at a time earlier than a starting time of an on-duration of the DRX cycle by a time duration shorter than a threshold duration, start no on-duration timer for the DRX cycle; or start an on-duration timer based on an end of the uplink transmission and a time offset configured for the terminal device.

In some embodiments, the circuitry may be further configured to: in accordance with a determination that the uplink transmission is performed on the uplink resource within the time window and that no wake-up signal is received, perform one of the following: a first operation of starting no on-duration timer for an associated DRX cycle; or a second operation of starting an on-duration timer for the associated DRX cycle. In some embodiments, the circuitry may be further configured to: receive, from the network device, an indication indicating the first operation or the second operation.

In these embodiments, the circuitry may be further configured to perform a monitoring in an on-duration of the DRX cycle based on a first SSSG associated with the uplink transmission. In some embodiments, the first SSSG comprises no DCI format for downlink scheduling. In some embodiments, the circuitry may be configured to perform the monitoring by: in accordance with a determination that the first SSSG comprises a DCI format for downlink scheduling, performing no monitoring on the DCI format for downlink scheduling in the first SSSG.

In some embodiments, the circuitry may be further configured to: in accordance with a determination that the uplink transmission is performed on the uplink resource within the time window and that a wake-up signal having a first value is received, start an on-duration timer for an associated DRX cycle; or in accordance with a determination that the uplink transmission is performed on the uplink resource within the time window and that a wake-up signal having a second value is received, start no on-duration timer for the associated DRX cycle. In some embodiments, the first value indicates a starting of the on-duration timer or a positive acknowledgement of the uplink transmission, and the second value indicates no starting of the on-duration timer or a negative acknowledgement of the uplink transmission.

In these embodiments, the circuitry may be further configured to: perform a monitoring in an on-duration of the DRX cycle based on a first SSSG associated with the uplink transmission and a second SSSG associated with the wake-up signal; or perform the monitoring in the on-duration of the DRX cycle based on a predetermined search space set group.

In some embodiments, the first SSSG comprises no DCI format for downlink scheduling. In some embodiments, the circuitry may be configured to perform the monitoring by: in accordance with a determination that the first SSSG comprises a DCI format for downlink scheduling, performing no monitoring on the DCI format for downlink scheduling in the first SSSG. In some embodiments, the second SSSG comprises no DCI format for uplink scheduling. In some embodiments, the circuitry may be configured to perform the monitoring by: in accordance with a determination that the second SSSG comprises a DCI format for uplink scheduling, performing no monitoring on the DCI format for uplink scheduling in the second SSSG.

In some embodiments, the circuitry may be further configured to: in accordance with a determination that no uplink transmission is performed on the uplink resource within the time window and that a wake-up signal indicating a starting of an on-duration timer for an associated DRX cycle is received, start the on-duration timer for the associated DRX cycle. In some embodiments, the circuitry may be further configured to perform a monitoring in an on-duration of the DRX cycle based on a second search space set group (SSSG) associated with the wake-up signal. In some embodiments, the second SSSG comprises no DCI format for uplink scheduling. In some embodiments, the circuitry may be configured to perform the monitoring by: in accordance with a determination that the second SSSG comprises a DCI format for uplink scheduling, performing no monitoring on the DCI format for uplink scheduling in the second SSSG.

In some embodiments, the associated DRX cycle is the next DRX cycle or the current DRX cycle with respect to the time window.

In some embodiments, a network device comprises a circuitry configured to: transmit, to a terminal device, a first configuration for a set of uplink resources; and determine a time window for the set of uplink resources, the time window being associated with a DRX cycle, an uplink resource within the time window in the set of uplink resources being used for an uplink transmission and an uplink resource outside the time window in the set of uplink resources being invalid for transmission, wherein the uplink transmission comprises at least one of a SR, a BSR, or a configured grant UL transmission.

In some embodiments, the circuitry may be configured to determine the time window by: transmitting, to the terminal device, a second configuration indicating the time window; and determining the time window based on the second configuration. In some embodiments, the second configuration comprises at least one of a duration, a periodicity or an offset of the time window. In some embodiments, the periodicity of the time window may be the same as a periodicity of the DRX cycle.

In some embodiments, the circuitry may be configured to determine the time window based on the second configuration by: determining a first time instance based on a reference time, the periodicity and an index of the time window; determining a second time instance based on the first time instance; determining a starting time of the time window based on the second time instance and the offset; and determining the time window based on the starting time and the duration.

In some embodiments, the circuitry may be configured to determine the time window by: determining a starting time of the time window based on a starting time of an on-duration of the DRX cycle and a first offset value configured for the terminal device; and determining an ending time of the time window based on at least one of the following: a duration of the time window configured for the terminal device; a second offset value configured for the terminal device and the starting time or an ending time of the on-duration of the DRX cycle; the ending time of the on-duration of the DRX cycle; or a time at which the terminal device gets into inactive time.

In some embodiments, the circuitry may be further configured to: in accordance with a determination that the uplink transmission is performed on the uplink resource within the time window, start an on-duration timer for an associated DRX cycle.

In some embodiments, the circuitry may be further configured to: in accordance with a determination that the uplink transmission is performed on the uplink resource within the time window at a time earlier than a starting time of an on-duration of the DRX cycle by a time duration shorter than a threshold duration, start no on-duration timer for the DRX cycle; or start an on-duration timer based on an end of the uplink transmission and a time offset configured for the terminal device.

In some embodiments, the circuitry may be further configured to: in accordance with a determination that the uplink transmission is performed on the uplink resource within the time window and that no wake-up signal is received by the terminal device, perform one of the following: a first operation of starting no on-duration timer for an associated DRX cycle; or a second operation of starting an on-duration timer for the associated DRX cycle. In some embodiments, the circuitry may be further configured to: transmit, to the terminal device, an indication indicating the first operation or the second operation.

In some embodiments, the circuitry may be further configured to perform a downlink transmission in an on-duration of the DRX cycle based on a first SSSG associated with the uplink transmission. In some embodiments, the first SSSG comprises no DCI format for downlink scheduling. In some embodiments, the circuitry may be further configured to perform the downlink transmission by: in accordance with a determination that the first SSSG comprises a DCI format for downlink scheduling, performing no transmission of the DCI format for downlink scheduling in the first SSSG.

In some embodiments, the circuitry may be further configured to: in accordance with a determination that the uplink transmission is performed on the uplink resource within the time window and that a wake-up signal having a first value is transmitted, start an on-duration timer for an associated DRX cycle; or in accordance with a determination that the uplink transmission is performed on the uplink resource within the time window and that a wake-up signal having a second value is transmitted, start no on-duration timer for the associated DRX cycle. In some embodiments, the first value indicates a starting of the on-duration timer or a positive acknowledgement of the uplink transmission, and the second value indicates no starting of the on-duration timer or a negative acknowledgement of the uplink transmission.

In some embodiments, the circuitry may be further configured to: perform a downlink transmission in an on-duration of the DRX cycle based on a first search space set group associated with the uplink transmission and a second search space set group associated with the wake-up signal; or perform a downlink transmission in the on-duration of the DRX cycle based on a predetermined search space set group.

In some embodiments, the first SSSG comprises no DCI format for downlink scheduling. In some embodiments, the circuitry may be configured to perform the downlink transmission by: in accordance with a determination that the first SSSG comprises a DCI format for downlink scheduling, performing no transmission of the DCI format for downlink scheduling in the first SSSG. In some embodiments, the second SSSG comprises no DCI format for uplink scheduling. In some embodiments, the circuitry may be configured to perform the downlink transmission by: in accordance with a determination that the second SSSG comprises a DCI format for uplink scheduling, performing no transmission of the DCI format for uplink scheduling in the second SSSG.

In some embodiments, the circuitry may be further configured to: in accordance with a determination that no uplink transmission is performed on the uplink resource within the time window and that a wake-up signal indicating a starting of an on-duration timer for an associated DRX cycle is transmitted, start the on-duration timer for the associated DRX cycle.

In some embodiments, the circuitry may be further configured to perform a downlink transmission in an on-duration of the DRX cycle based on a second SSSG associated with the wake-up signal. In some embodiments, the second SSSG comprises no DCI format for uplink scheduling. In some embodiments, the circuitry may be configured to perform the downlink transmission by: in accordance with a determination that the second SSSG comprises a DCI format for uplink scheduling, performing no transmission of the DCI format for uplink scheduling in the second SSSG.

In some embodiments, the associated DRX cycle is the next DRX cycle or the current DRX cycle with respect to the time window.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-49. (canceled)

50. A method of communication performed by a terminal device, the method comprising:
receiving, from a network device, a first resource configuration for an uplink transmission, wherein the uplink transmission comprises at least one of a scheduling request and a configured grant transmission;
transmitting the uplink transmission in an active period in a discontinuous reception (DRX) cycle within the first resource configuration; and
controlling not to transmit the uplink transmission within the first resource configuration that is outside the active period.

51. The method of claim 50, further comprising:
receiving, from the network device, a configuration for DRX related parameters, wherein the configuration comprises a parameter indicating a timer corresponding to a duration of the active period.

52. The method of claim 51, wherein the active period includes a time duration while the timer is running.

53. The method of claim 51, further comprising:
receiving, from the network device, information indicating at least one of a periodicity and an offset of the DRX cycle.

54. A method of communication performed by a network device, the method comprising:
transmitting, to a terminal device, a first resource configuration for an uplink transmission, wherein the uplink transmission comprises at least one of a scheduling request and a configured grant transmission;
receiving the uplink transmission in an active period in a discontinuous reception (DRX) cycle within the first resource configuration, wherein the uplink transmission is controlled not to be transmitted within the first resource configuration that is outside the active period.

55. The method of claim 54, further comprising:
transmitting, to the terminal device, a configuration for DRX related parameters, wherein the configuration comprises a parameter indicating a timer corresponding to a duration of the active period.

56. The method of claim 55, wherein the active period includes a time duration while the timer is running.

57. The method of claim 55, further comprising:
transmitting, to the terminal device, information indicating at least one of a periodicity and an offset of the DRX cycle.

58. A terminal device, comprising:
at least one memory having program instructions stored therein; and
one or more processors configured to execute the program instructions that when executed control the terminal device to perform operations comprising:
receiving, from a network device, a first resource configuration for an uplink transmission, wherein the uplink transmission comprises at least one of a scheduling request and a configured grant transmission;
transmitting the uplink transmission in an active period in a discontinuous reception (DRX) cycle within the first resource configuration; and
controlling not to transmit the uplink transmission within the first resource configuration that is outside the active period.

59. The terminal device of claim 58, wherein the operations further comprise:
receiving, from the network device, a configuration for DRX related parameters, wherein the configuration comprises a parameter indicating a timer corresponding to a duration of the active period.

60. The terminal device of claim 59, wherein the active period includes a time duration while the timer is running.

61. The terminal device of claim 59, wherein the operations further comprise:
receiving, from the network device, information indicating at least one of a periodicity and an offset of the DRX cycle.
